(19) United States
(12) Patent Application Publication
(10) Pub. No.: US 2018/0000195 A1
(43) Pub. Date: Jan. 4, 2018

(54) THERMOFORMING FOOTWEAR METHOD

(71) Applicant: Skysole Corporation, Hermosa Beach, CA (US)

(72) Inventors: Joseph Skaja, Hermosa Beach, CA (US); Jerome Gross, Hermosa Beach, CA (US)

(21) Appl. No.: 15/705,127

(22) Filed: Sep. 14, 2017

Related U.S. Application Data
(62) Division of application No. 14/725,775, filed on May 29, 2015.
(60) Provisional application No. 62/005,494, filed on May 30, 2014.

(51) Int. Cl. A43B 9/12; A43B 23/02; A43D 25/07; B29D 35/06

(52) U.S. Cl. CPC A43B 9/12; B29D 35/06; A43B 23/0255; A43B 23/026; A43D 25/07

(57) ABSTRACT

An article of footwear and method of manufacturing an article of footwear comprises an upper, a sole structure adjacent the upper and a thermoplastic material sheet attached to the upper to fixedly secure one or more components to the upper or fixedly secure the upper to a sole structure where the thermoplastic material sheet provides the primary or only means for securing the components to the upper and the upper to the sole structure.

### CROSS-REFERENCES TO RELATED APPLICATIONS

This is a Divisional application based on U.S. Ser. No. 14/725,775, filed on May 29, 2015, which claims priority from U.S. Application No. 62/005,494, filed May 30, 2014, which are incorporated by reference in their entirety.

### BACKGROUND

Conventional methods of manufacturing footwear include cutting fabric or other textile material to form uppers and then stitching and/or gluing the uppers to a midsole or an outsole. The footwear manufacturing steps are labor intensive, involve toxic or environmentally harmful adhesives and solvents and require expensive machinery. Thus, there is a need to simplify the manufacturing process, reduce equipment and labor costs and reduce or eliminate the use of toxic or environmentally harmful substances in the manufacturing process.

### SUMMARY OF THE INVENTION

The present thermoformed shoe and thermoforming process simplifies the manufacturing process by attaching one or more footwear components or an upper to a sole structure solely or primarily with a thermoplastic material sheet with minimal use of (or reduced) adhesive, sewing or other attachment method.

In an embodiment, an article of footwear is provided and comprises an upper, a sole structure adjacent the upper and a thermoplastic material sheet attached to the upper to fixedly secure one or more components to the upper or fixedly secure the upper to a sole structure where the thermoplastic material sheet provides the primary or only means for securing the components to the upper and the upper to the sole structure.

In another embodiment, a method of manufacturing footwear includes providing an upper and a sole structure, heating a thermoplastic material sheet and pressing the thermoplastic material sheet over the upper and at least a portion of the sole structure to fixedly attach the upper to the sole structure.

In a further embodiment, a method of making at least a footwear upper includes removably attaching a base material layer to a last, placing at least one component on the base material layer, heating a thermoplastic material sheet, applying the heated thermoplastic material sheet to the base material layer and over the at least one component, while the base material layer is attached to the last to fixedly attach the at least one component to the base material layer and form at least a portion of a footwear upper and removing the footwear upper portion from the last.

### BRIEF DESCRIPTION OF THE DRAWINGS

FIG. 1 is a perspective view of an embodiment of a shoe made by the thermoforming process of the present invention.

FIG. 2 is a perspective view of an embodiment of a last of the present invention.

FIG. 3 is a perspective view of an embodiment of an upper formed by a base material placed on the last of FIG. 2.

FIG. 4 is a perspective view of the upper of FIG. 3 including a plurality of footwear components attached to the base material.

FIG. 5 is a perspective view of an embodiment of a shoe of the present invention made by attaching a midsole to the upper of FIG. 4.

FIG. 6 is a perspective view of the shoe of FIG. 5 including an outsole attached to the midsole.

FIG. 7 is a partial perspective view of an embodiment of a thermoforming machine of the present invention.

FIG. 8 is a partial perspective view of the thermoforming machine of FIG. 7 showing a heater positioned adjacent to the thermoplastic polyurethane sheet.

FIG. 9 is a bottom plan view of an embodiment of a shoe mold housing of the thermoforming machine of FIG. 7.

FIG. 10 is a side view of the shoe mold housing of FIG. 9.

FIG. 11 is a side view of the thermoforming machine of FIG. 7 showing the upper frame member moved toward the lower frame member to thermoform an upper of a shoe.

FIG. 12 is a side view of a thermoformed upper of a shoe on the lower frame member shown in FIG. 11 prior to trimming the excess portions of the thermoplastic polyurethane sheet from the upper.

FIG. 13 is a top view of an embodiment of a base material layer including one or more materials laminated to the base material layer.

FIG. 14 is perspective view of a shoe made by the thermoforming process of the present invention where a pre-molded collar is positioned about the foot opening and thermoformed to the upper.

FIG. 15 are top and bottom views of an embodiment of the pre-formed collar of FIG. 14.

FIG. 16 is a side view of an embodiment of a shoe mold assembly of the thermoforming machine of FIG. 7 that includes two liners.

FIG. 17 is a bottom view of the shoe mold assembly of FIG. 16.

FIG. 18 is a side view of an embodiment of a sole structure for a shoe made by the thermoforming process of the present invention where the sole structure includes a groove for guiding a cutting tool during the trimming process.

FIG. 19 is a side view of another embodiment of a shoe mold assembly of the thermoforming machine of FIG. 7 that includes an inverted mold.

FIG. 20 is a side view of a further embodiment of the present thermoforming machine where the upper is inverted prior to the thermoforming process.

### DETAILED DESCRIPTION OF THE PREFERRED EMBODIMENTS

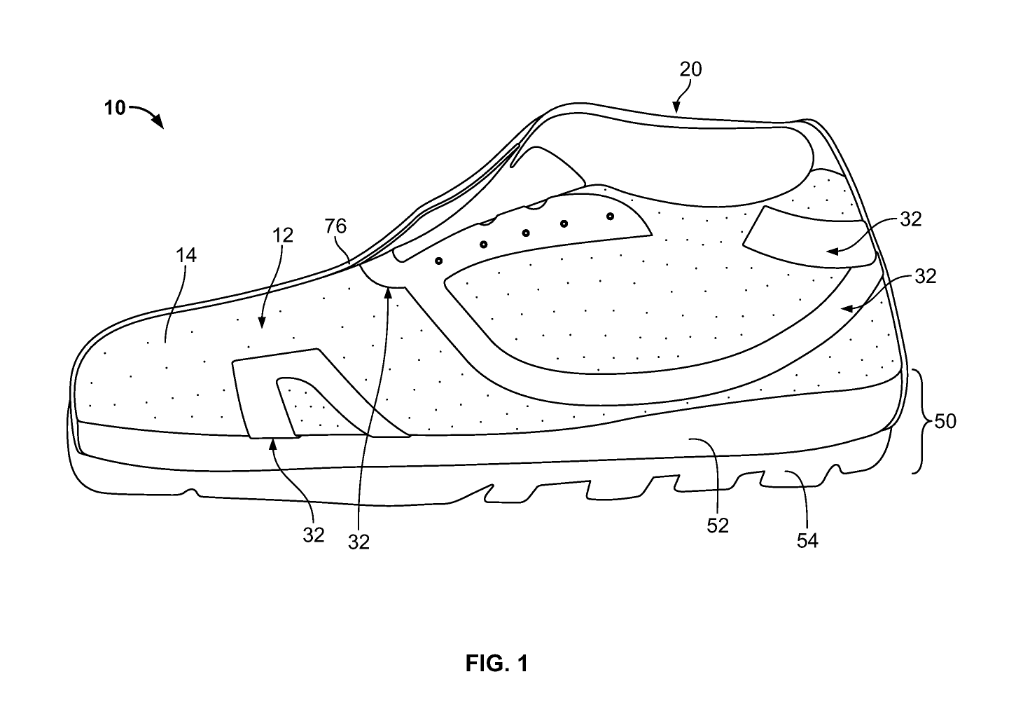

FIG. 1 shows an article of footwear, and more specifically, a shoe, made by a thermoforming process described below. The thermoforming process forms a footwear upper by thermoforming or overmolding a piece of thermoplastic polyurethane (TPU) or other moldable material over a base layer made of one or more pieces of material for, i.e., for the forefoot, vamp, quarters and/or other parts of the upper, and one or more footwear components. Additionally, a sole or a sole structure may be attached to the footwear upper during the thermoforming process. The sole structure may include, but is not limited to, one or more of: a midsole, an outsole, a unitary sole, a sole shell that is hollow and includes one or more cushioning materials or elements, a cushioning material layer or layers or any suitable material or materials. It should be appreciated that the footwear upper may be an upper for a shoe, boot, sandal or other article of footwear.

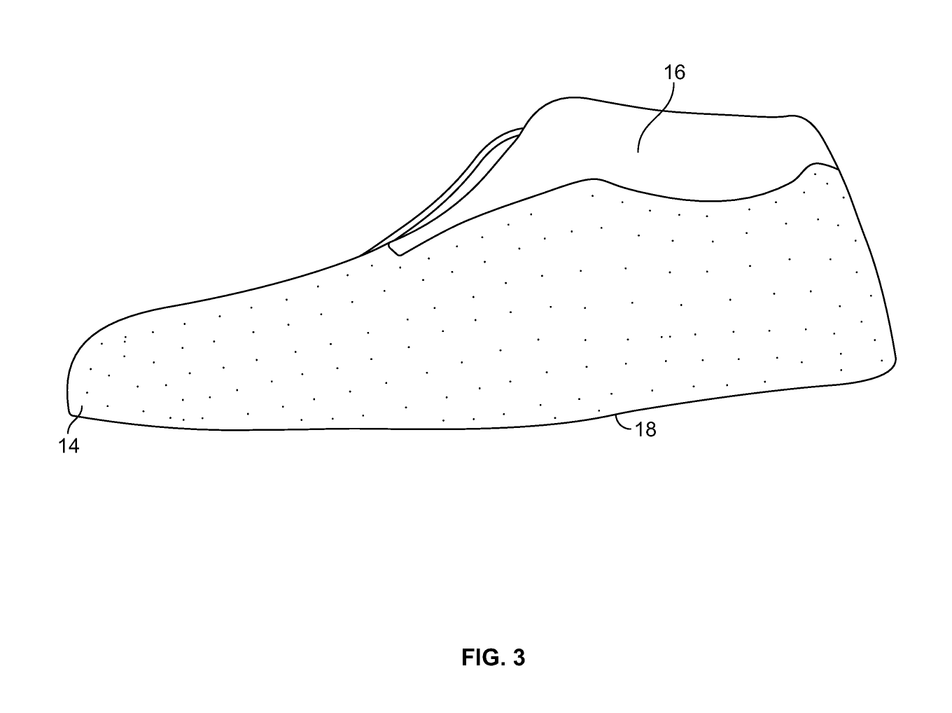

Referring to FIGS. 1-6, the shoe 10 includes an upper 12 having a base layer 14. Prior to thermoforming or overmolding the upper, the base layer 14 is stretched or placed over a last or core 16 so that it mimics the shape of the last. To secure the base layer 14 to the last 16, opposing bottom sides/edges 18 of the base layer are interconnected by a lasting method such as strobel lasting, i.e., stitching an insole to a bottom edge of the upper, to initially form the upper 12. Alternatively, the upper 12 may be formed by string lasting, i.e., the bottom edges of the upper are connected by threading one or more strings through the bottom edges in a straight or criss-crossing pattern, or connected by a lasting board, a piece of material or other suitable connecting member. Alternatively, the upper may be temporarily attached to the last 16 by using a multi-use adhesive, drawing a vacuum through the last, using hook and loop materials, using magnets or other suitable temporary attachment devices and methods. In this way, the overmolding is performed on the upper 12 without having to use the lasting procedure described above.

In an embodiment, the upper 12 may be formed by a tubular knit material, such as a tubular fabric, where the last 16 is inserted into the upper through an opening in the tubular material such as the foot opening 20. For example, the base layer 14 may be formed by knitting or weaving the base layer into a tube with a closed end similar to how a sock is made. The tubular base layer or sock may be formed with different thicknesses, stretch, breathability and/or patterns in different areas of the base layer to create specific functional zones. By altering the construction in specific areas of the sock, a highly functional upper can be made that also has an inner surface that is comfortable against a wearer's foot. The sock can also be made with one or more materials, and decorated and colored to complement the color and texture of other materials used to form the upper. Further, forming the upper as a sock helps eliminates material waste and simplifies the manufacturing process by eliminating some of the extra finishing steps needed for form the upper.

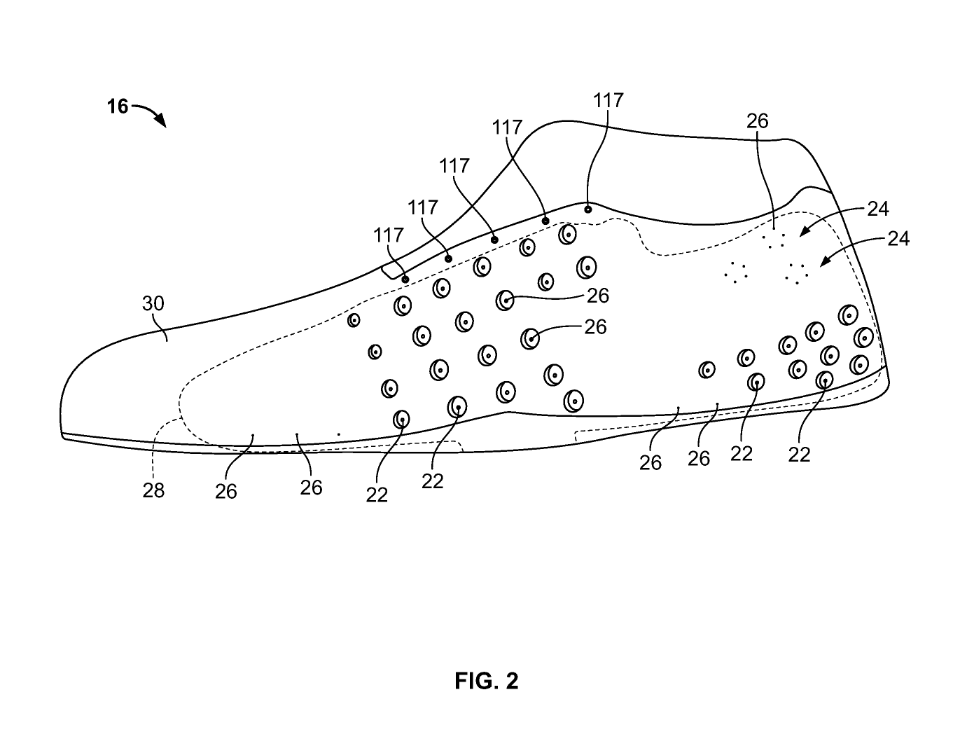

FIG. 2 shows a thermoforming mold, such as the last 16, which is made of a durable material such as a solid thermoplastic material, metal such as aluminum, wood, plastic, a composite material or any suitable material. In the illustrated embodiment, at least a portion of the last 16 includes shaped indentations, recessed areas and holes that are used to form a pattern in the base layer and/or components. In the example embodiment shown in FIG. 2, the last 16 includes a plurality of circular recessed areas 22 and circular designs 24 formed by a plurality of recessed openings or holes 26. It should be appreciated that the recessed areas 22 and designs 24 may be any suitable shapes, symbols or characters. In the illustrated embodiment, an interior 28 of the last 16 is hollow or includes a hollow area for enabling at least a partial vacuum to be drawn through a plurality of holes 24 and/or 26 in the last that extend from the outer surface 30 to the hollow interior 28.

One or more material manipulating tools (not shown) may also be associated with or attached to the last 16. For example, one or more air tubes may be attached to an inner surface of the last such that air is blown outwardly from one or more areas on the last to manipulate the thickness of the TPU on the upper and/or sole structure as it is being overmolded on the upper and/or the sole structure. Another tool (not shown) may be used to fold at least a portion of the TPU underneath the upper or the sole structure. It should be appreciated that any suitable manipulating tool or tools may be used to change the properties and/or location of the TPU on the upper and the sole structure.

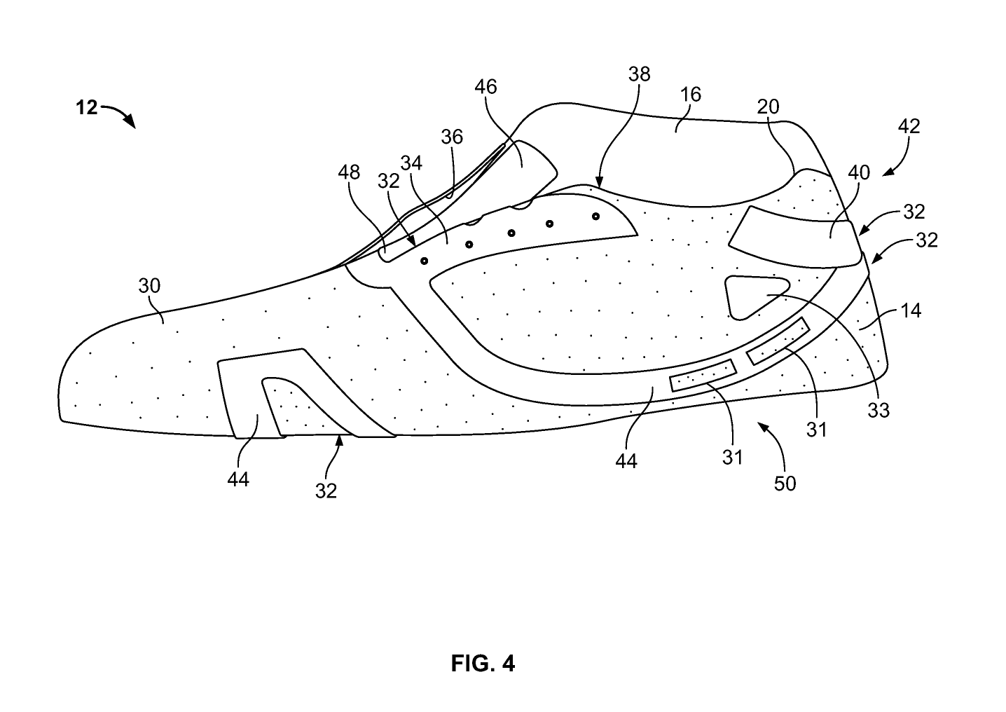

While the upper is on the last, one or more components 32 are temporarily attached to the base layer 14. The components 32 can be temporarily attached to or held on the base layer 14 by using a multi-use adhesive, drawing a partial vacuum through the last, using hook and loop materials, using magnets or other suitable temporary attachment devices and methods. It should be appreciated that a partial vacuum can be generated based on any suitable vacuum generation method or process including using a non-hollow last or mold. The overmolded thermoplastic layer then conforms and holds the components 32 in place on the base layer 14 as described below. Various apertures 31 (FIG. 4) can be formed in a given component or components 32 to expose the base layer so that the thermoplastic layer further bonds the components to the base layer 14 during the overmolding process. The apertures or openings may also be formed in any material layer or layers on the base layer 14 to enhance the bond between those layers. Also, the base layer 14 may include one or more apertures 33 (FIG. 4) for strengthening the bond between the base layer and one or more internal shoe components such as an inner material liner, cushioning materials, a heel counter or other components.

In the illustrated embodiment, the components 32 include an eye stay 34 positioned about a central opening 36 in the upper, a collar 38 for reinforcing an area around the foot opening 20 and a heel support or heel foxing 40 for reinforcing and supporting the heel 42. Additional components 44 are attached to opposing sides of the upper 12 for structural support and/or aesthetic purposes. It should be appreciated that one or more of the components 32 may cover a portion or portions of the base layer 14 or the entire base layer. It is also contemplated that the base layer 14 and one or more of the components 32 may be the same material or different materials. In the illustrated embodiment, the base layer 14 and/or the components 32 may be ethylene vinyl acetate (EVA), rubber, fabric, textile, foam or any suitable material or combination of materials. Additionally, the base layer 14 may include openings, vents and/or a mesh material to enhance the breathability and comfort of the shoe.

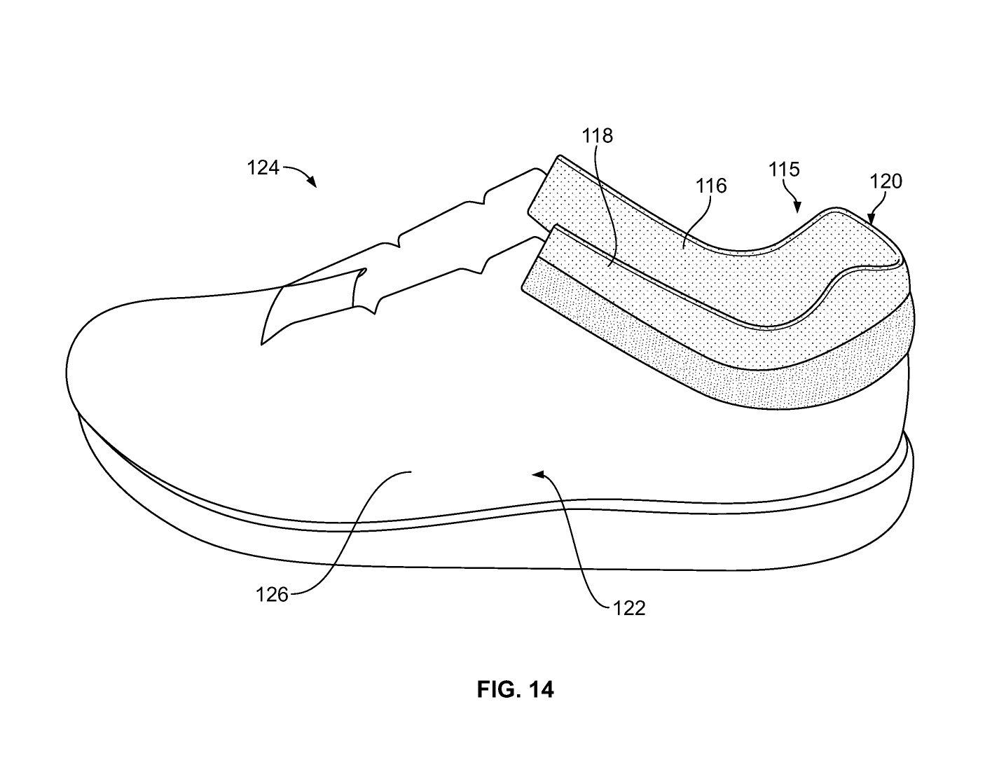

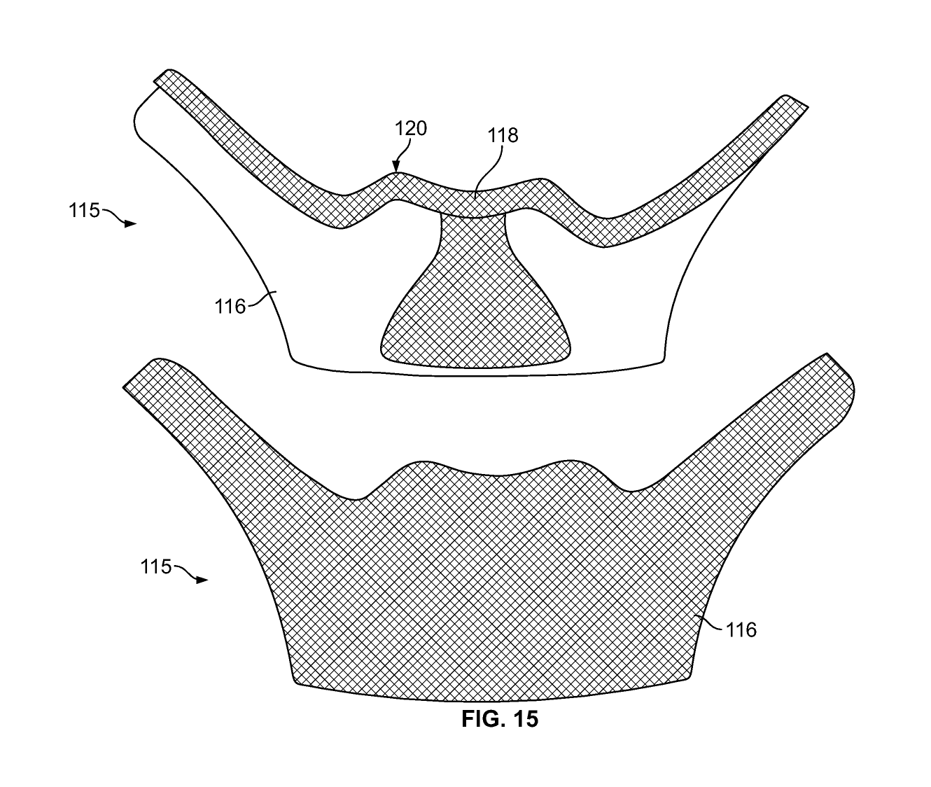

Referring to FIGS. 14-15, in an embodiment, a collar 115 is pre-formed or pre-molded as a single, component having an inner portion 116 and an outer portion 118. The ends of the inner portion 116 and the outer portion 118 are integrally connected to form a hinge 120 so that the inner and outer portions pivot relative to each other. In the illustrated embodiment, the pre-formed collar 115 includes one or more holes that are temporarily held or secured to the last 16 by one or more pins 117 extend from the last 16 (FIG. 2) and an internal rib that accurately indexes the collar to the last. After securing the pre-formed collar 115 to the last, the base layer 122 is moved upwardly between the inner and outer portions 116, 118 so that the inner portion is positioned generally adjacent to the inner surface of the upper 124 and the outer portion or outer flap of the collar is positioned partially over the outer surface 126 of the base layer 122 so that the outer portion is visible on the outer surface of the shoe. It should be appreciated that the pre-formed collar 115 may be secured to the last using any suitable connection method. Alternatively, the pre-formed collar 115 can initially be placed on the base layer 122 and then the combined base layer and collar are secured to the last. Now, during the thermoforming process, the collar 115 is thermoformed or overmolded on the base layer. Attaching the collar and/or other components to the base layer in a single step as described above, saves significant time and money over conventional methods of attaching the collar to the upper, which include stitching and/or gluing the collar to the upper after the upper was made. It should be appreciated that the pre-formed collar 115 may be made with a single material or a combination of materials and/or may have the same thickness or areas with different thicknesses. For example, the inner portion may be made with a thicker, cushioning material or materials to provide extra support and comfort to a wearer's foot. The material or materials used to make the pre-formed collar may include fabric or any suitable materials and may include one or more patterns and colors.

A tongue 46 is another component that can be attached to the upper 12 during the thermoforming process by cutting a piece of material in a desired shape and placing the piece of material on the upper so that the piece of material at least partially overlaps a portion of the base layer 14. To ensure that only a portion of the tongue 46, namely the distal end 48 of the tongue, is attached to the base layer 14, a shield or cover plate is placed over the tongue so that only the portion of the tongue being attached to the base layer is exposed and overmolded by TPU during the thermoforming process. It is contemplated that other components 32 such as a toe cap, reinforcements and/or logos may also be temporarily attached to the base layer 14.

FIG. 5 shows a sole structure 50, and more specifically, a midsole 52 attached to the upper 12. The midsole 52 may be made of EVA, R-MAT™ foam, foam, ethylvinyl acetate, rubber or another suitable material or combination of materials. In this embodiment, the upper 12 is positioned on, but not fixed to, the midsole 52. As described below, the upper 12 is attached to the midsole 52 during the thermoforming process. It should be appreciated that the thermoforming process can be used to form the upper with or without a sole structure.

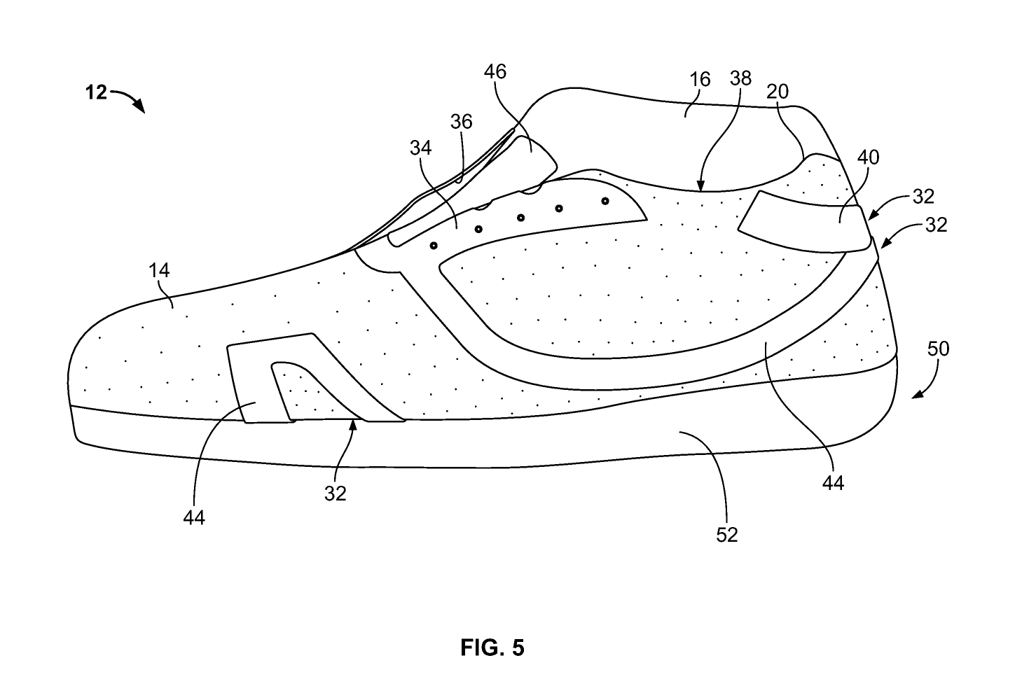

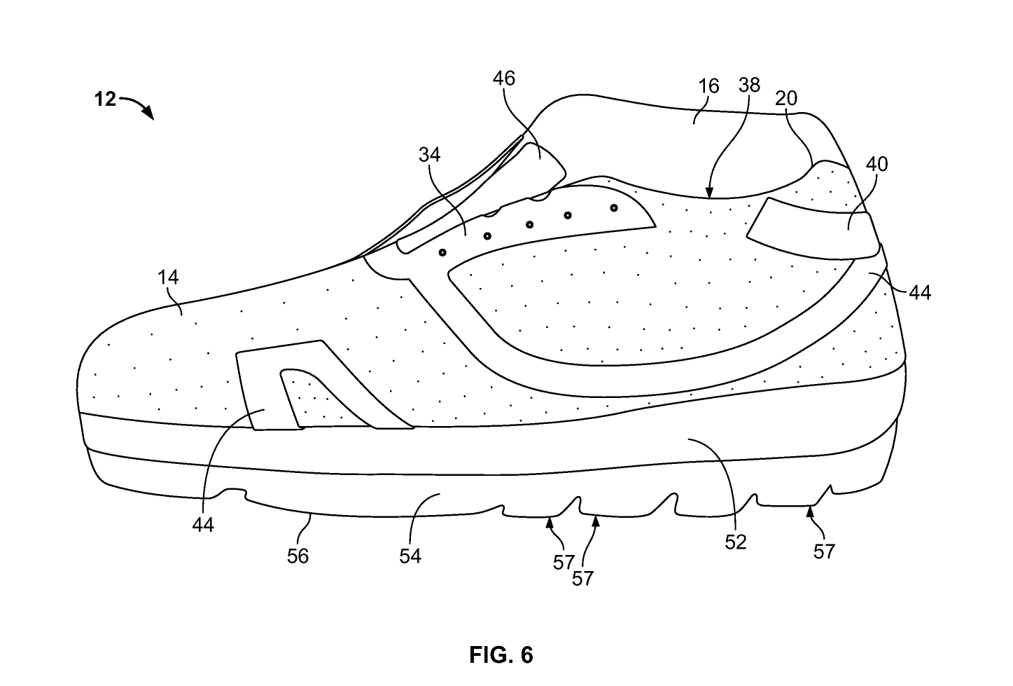

FIG. 6 shows another part of the sole structure 50, namely an outsole 54, attached to the midsole 52. In the illustrated embodiment, the outsole 54 is made of rubber but may be made with any suitable material or combination of materials. A bottom surface 56 of the outsole 54 includes a plurality of tread members 57 that enable the outsole to grip an underlying surface such as the ground or a floor. In an embodiment, the outsole 54 is attached to the midsole 52 by adhesive, stitching or another suitable attachment method. It is also contemplated that the outsole 54 can be attached to the midsole 52 by the present thermoforming process or a combination of these processes.

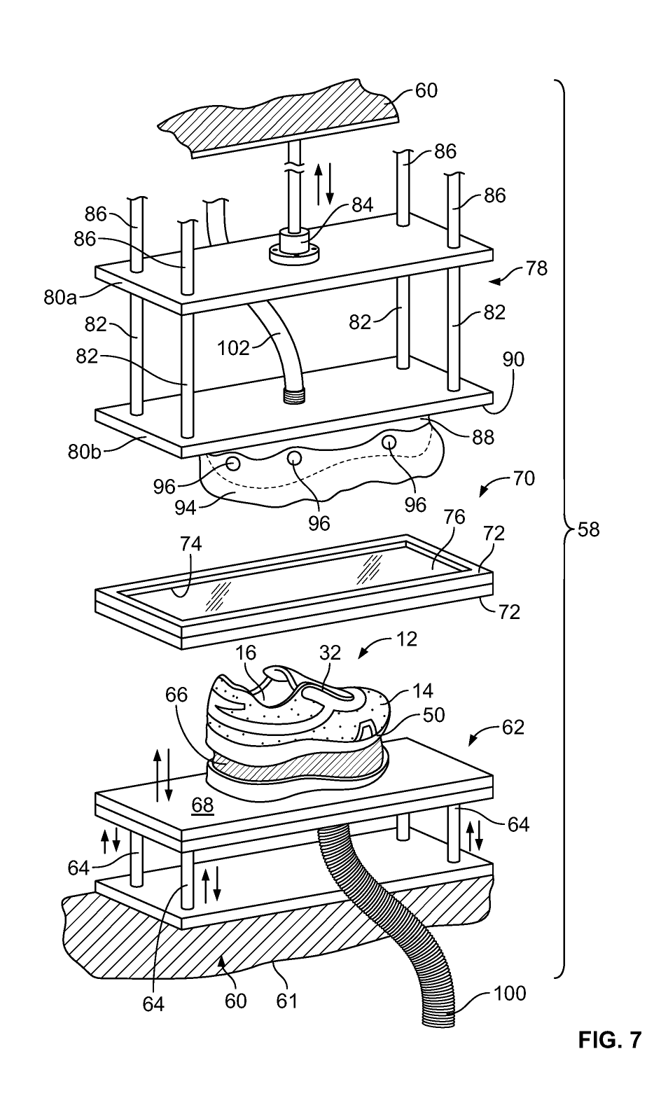

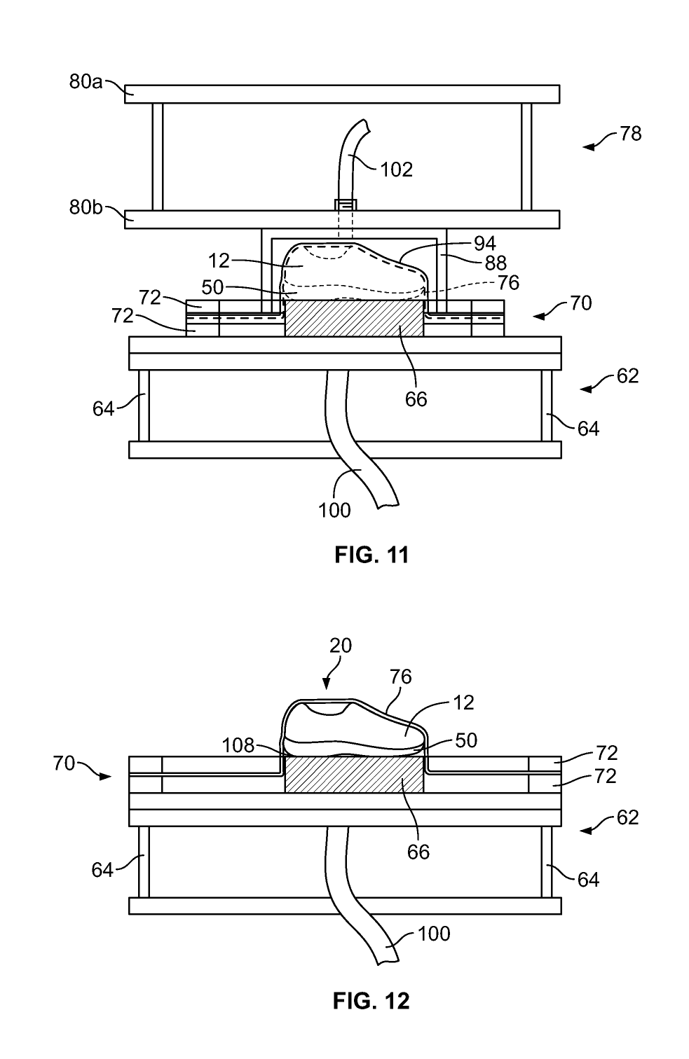

FIGS. 7-12 shows some of the parts of the machine that performs the thermoforming or overmolding process for forming the upper 12 and/or attaching a sole structure 50 to the upper.

More specifically, a thermoforming machine 58 includes a frame 60 having a mold sub-base 61 and a lower frame member (mold base A) 62 that is movably connected to the frame by one or a plurality of mold base guides such as hydraulic or air cylinders 64 located generally at each corner of the lower frame member. A support member or pedestal (mold base B) 66 is attached to a top surface 68 of the lower frame member 62 and has a size and shape that corresponds to a size and shape of an article or articles of footwear for supporting the footwear during the thermoforming process. In the illustrated embodiment, the midsole 52 is placed on the pedestal 66 and then the upper 12 (including the last 16) is placed on the midsole. Optionally, one or more pins or pegs may be inserted through an inside surface of the upper 12 and midsole 52 and into the pedestal 66 to temporarily hold the upper and midsole in place during the thermoforming process. The pins may also be part of the pedestal 66 and extend outwardly such that when the upper 12 and midsole 52 are placed on the pedestal, the pins project through the midsole and upper to hold them in place. It should be appreciated that the upper 12 and the sole structure 50 may also be joined together and then secured to the pedestal 66.

A clamping member 70 is attached to the frame 60 and is initially positioned over the upper 12 and the sole structure, i.e., midsole 52, on the pedestal 66. The clamping member 70 includes a pair of opposing rectangular clamping frames or brackets 72 each being the same general size and shape and each defining openings 74. A sheet of TPU 76 or other formable material is clamped between the brackets 72 to secure the TPU sheet in place. Alternatively, the TPU sheet 76 may be taped to one or both of the brackets 72 or secured to the brackets or another type of clamping member using any suitable connection method. The TPU sheet 76 has a designated thickness, hardness and other properties. Preferably, the TPU sheet 76 has a hardness of 60 to 85 Shore A. For example in the illustrated embodiment, the TPU sheet 76 is a 94 Shore A TPU sheet, which is generally around 0.010 inches thick. It should be appreciated that the thickness of the TPU sheet is selected according to design criteria, but will generally range from 0.004 to 0.100 inches, depending on the particular material properties. In an embodiment, the preferred thickness ranges from 0.060 to 0.080 inches but may be any suitable thickness. The TPU sheet 76 may also include one or more perforations, holes or openings. Alternatively, the TPU sheet 76 may have a non-uniform thickness, i.e., different thicknesses in different areas, and different properties by using multiple material layers in different areas of the TPU sheet. As an example, the TPU sheet 76 may be thicker along the edge of the sole structure 50 to enhance the strength of the TPU in this area. A composite layered sheet may also be used to enhance strength. It should be appreciated that other types of materials or combination of materials may be used other than TPU.

As shown in FIG. 7, a shoe housing assembly including an upper frame member 78 is positioned on an opposing side of the clamping member 70 from the lower frame member 62. The upper frame member 78 includes two, spaced platforms 80a and 80b joined together by four support posts 82 each located at a corner of the platforms. Further, a main hydraulic or air cylinder 84 attachment member and one or more outer hydraulic or air cylinders, such as four outer hydraulic cylinders 86 are attached to the top platform 80a to movably connect the upper frame member 78 to the frame 60. As shown by the arrows in FIG. 7, the upper and lower frame members 78 and 62 each move toward and away from the clamping member 70 holding the TPU sheet 76.

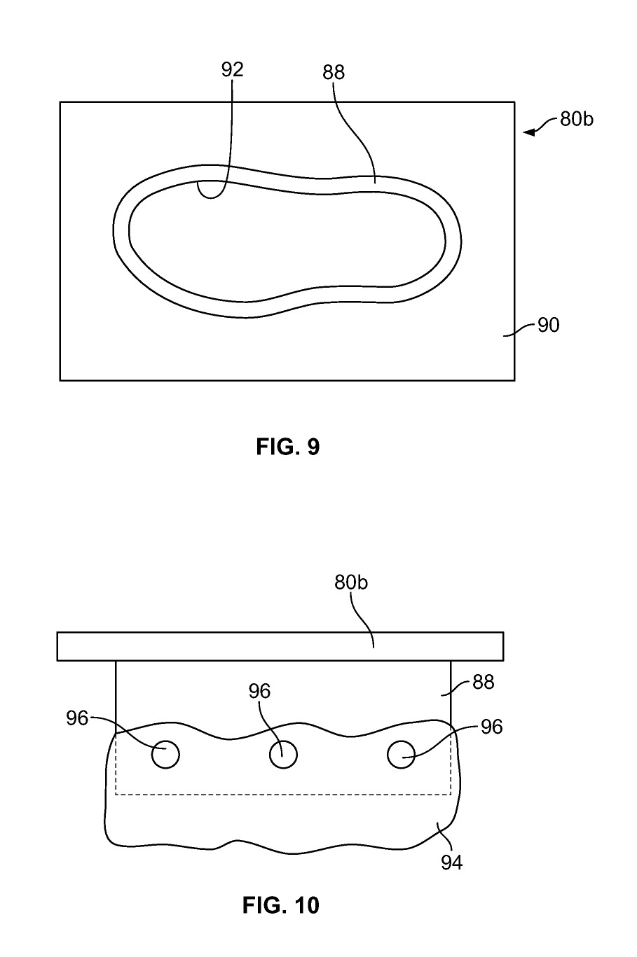

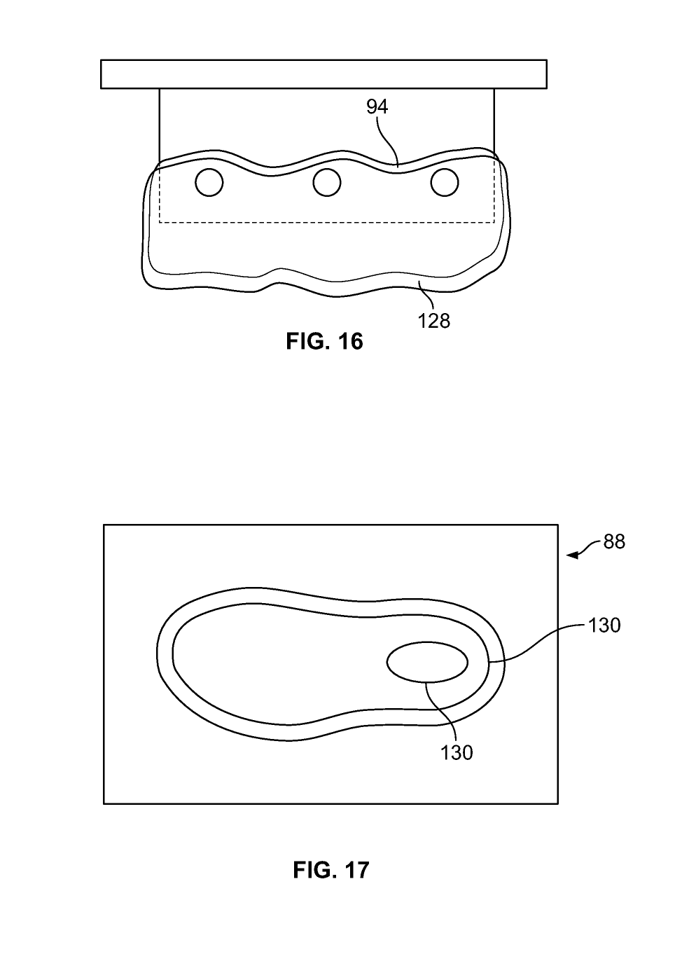

A pressure box or shoe mold housing, such as mold member 88, is attached to a bottom surface 90 of the lower platform 80b. The mold member 88 has an interior hollow area 92 (FIG. 9) at least a portion of which has a size and shape that corresponds to the size and shape of the upper 12 and/or the sole structure 50. To help form the vacuum within the mold member and prevent the TPU sheet 76 from sticking to or adhering to the mold member 88, a flexible, silicone cover or liner 94 is secured to the mold member by connectors 96 and is configured to cover a bottom surface 98 of the mold member and form vacuum barrier. It should be appreciated that silicone and other similar materials with significant elongation properties may be used to make the liner 94 so that the liner applies significant pressure on the upper 12 and the sole structure 50 during the thermoforming process. It should also be appreciated that the liner 94 may be made with a suitable non-stick material or any other suitable material or combination of materials. Also, foam that is typically used to cushion and add comfort to the upper 12 can be replaced by installing cushioning structural elements such as hemispheres in the mold member 88. These structural elements can be of any size or shape and can be reinforced if necessary with inserted materials. The overmolded TPU sheet 76 will readily copy these shapes and mold any material that is in contact with it. Additionally, the overmolded TPU sheet 76 can be shaped during molding to provide stiffness and strength where desired. The liner 94 eliminates the need for matched compression tools and the corresponding accuracy associated with such tools and thereby significantly decreases costs associated with these tools. In another embodiment, a second liner 128 (FIG. 16), preferably made of a non-stick fabric, such as nylon, having maximum stretching capabilities, is inserted between the TPU sheet and the liner 94 to form or imprint the TPU with one or more textures. For example, the texture could be a criss-crossing pattern or other suitable patterns. The textures help to mask the plastic appearance or plastic surface of the TPU sheet on the finished shoe surface. Furthermore, textures are typically imprinted on an upper in a separate machining step at a different location from the shoe manufacturing location. By including texture or textures on the second liner 128, the cost and time associated with imprinting such texture(s) on the upper are significantly reduced. Alternatively, the liner 94 may have one or more textures that are imprinted or formed on the TPU sheet on the upper and/or sole structure during the thermoforming process.

Alternatively, the mold member 88 can be made out of silicone and thereby function without the liner 94. It should be appreciated that the mold member 88 may be made with a non-stick material or any other suitable material or combination of materials. The mold member 88 can also include protrusions or molded areas on its inner surface that apply pressure to certain points or locations on the upper and/or sole structure for pressing the TPU into recessed areas on the base layer or for forming patterns, indentations, grooves or other formations on the base layer and/or components.

Additionally, various materials can be attached to an inner surface of the mold member 88 where the materials contact the upper and the last as the TPU is making contact with the upper and the last. This method stabilizes the upper and the last and securely presses the sole structure and upper together so that there are no gaps or spaces between the upper and the sole structure thereby ensuring a tight connection between the upper and the sole structure. The mold member 88 can also include various manipulative robotic fixtures that can aid in the forming process.

A vacuum hose 100 is connected at one end to the lower frame member 62 and at an opposing end to a vacuum generator, e.g., a compressor or vacuum pump, located in or near the machine. Suitable tubing or piping extends from the interior hollow area 28 of the last 16 to the end of the vacuum hose connected to the lower frame member 62. Alternatively, the vacuum hose 100 may extend through the lower frame member 62 and connect directly to the bottom of the last 16 and thereby the hollow interior 28 of the last. The vacuum generator creates a designated partial vacuum level or amount of suction in the vacuum hose 100 for drawing air through the interior 28 and holes 26 in the last 16.

On an opposing side, a pressure hose 102 is connected at one end to the upper frame member 78 and at an opposing end to a pressure generator located in or near the machine. The pressure generator generates pressurized air at a designated pressure and supplies the pressurized air to the pressure hose 102, which in turn, directs the pressurized air into the mold member 88.

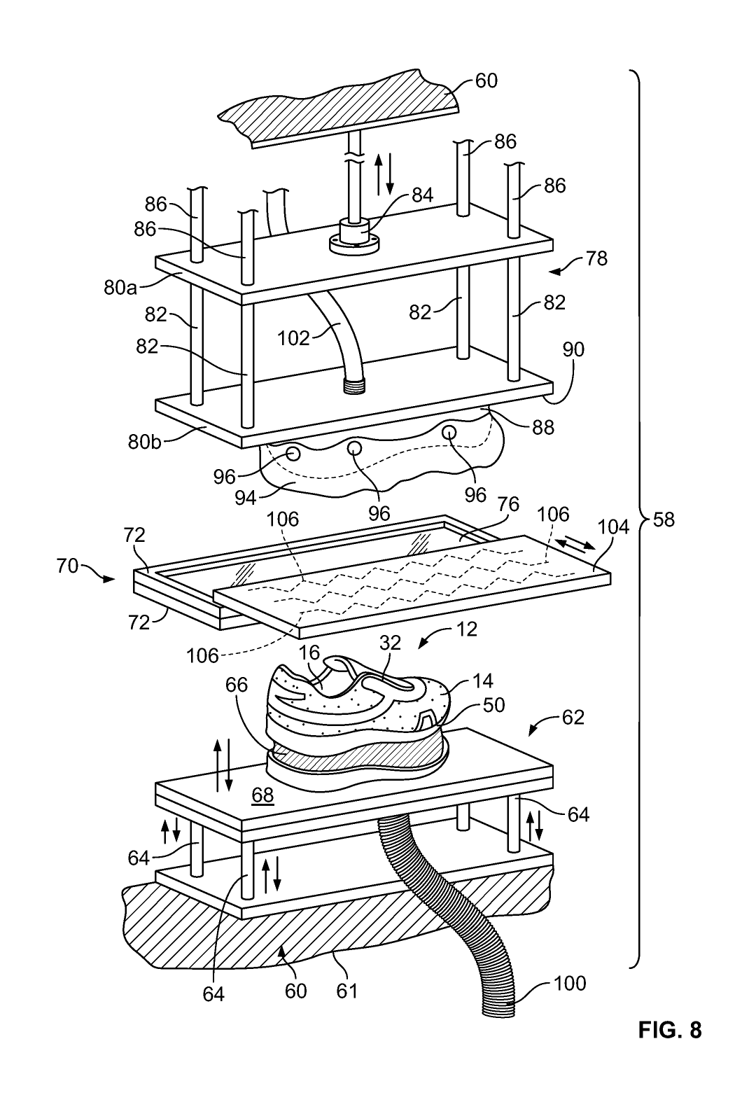

The thermoforming machine 58 also includes a heater 104 that is movably connected to the frame 60 and moves transverse to the movement of the upper and lower frame members 78 and 62. The heater 104 includes one or more heating elements 106 (FIG. 8), such as ceramic electric heating elements or coils, that are heated to a designated temperature. During the thermoforming process, the heater 104 is initially positioned over the clamping member 70 such that the heater moves between a first position in which the heater, and more specifically, the heating elements 106 are positioned over the TPU sheet 76, and a second position in which the heater 104 is moved away from the clamping member and TPU sheet. It should be appreciated that there are many different thermoforming machine configurations such as turn table designs/systems, automatic in-line systems and combinations of these systems. In this regard, the heaters in these systems may include any suitable heater or heaters such as an oven or ovens or one or more heating elements.

In an example, the upper 12 (including last 16) and the sole structure 50 (as shown in FIGS. 7 and 8) are placed on the pedestal 66 of the lower frame member 62. The heating elements 106 of the heater 104 are energized to heat to a designated or pre-programmed temperature. In the illustrated example, the TPU sheet 76 is heated to a temperature of 340-400 degrees F. but may soften or melt at significantly lower or higher temperatures. Other temperatures may be used depending on the properties of the TPU sheet. At the same time that the sheet 76 is being heated, the vacuum generator generates a partial vacuum in the vacuum hose 100, the pedestal 66 and the interior 28 of the last 16. The heater 104 is initially in the first position over the TPU sheet 76. As the heating elements 106 increase in temperature, the heat generated by the heating elements heats or increases the temperature of the TPU sheet 76 to a temperature approaching the melting point of the TPU. After reaching a designated temperature of the TPU, the heater 104 retracts or moves away from the TPU sheet 76.

Next, the upper and lower frame members 78 and 62 are moved together so that the upper 12 and sole structure 50 on the pedestal 66 are moved upwardly into the heated TPU sheet 76 and the upper frame member 78 simultaneously moves downwardly so that the mold member 88 moves into an opposing side of the TPU sheet until contacting the upper surface 108 of the lower frame member 62. In this position, the TPU sheet 76 is sealed off by contact of the peripheral edge of the mold member 88 with the surface 68 of the lower frame member 62 so that the upper 12 and sole structure 50 are enclosed between the mold member 88 and the lower frame member 62. The vacuum generated via vacuum hose 100 pulls and conforms the TPU sheet 76 on the upper and the sole structure. Similarly, the pressurized air from the pressure hose 102 pushes or presses the cover/liner 94 and thereby the TPU sheet 76 downwardly onto the upper 12 and the sole structure 50. Thus, in a single step, the TPU sheet 76 encapsulates and permanently attaches the components 32 and the sole structure 50 to the base layer 14 of the upper. It should be appreciated that the pressure hose 102 is optional and the process can be performed solely using the vacuum drawn through the last by the vacuum hose and vacuum generator.

Furthermore, heat from the TPU sheet 76, approximately a temperature of 400 degrees F., is transferred to the various components 32 when the upper 12 is overmolded with TPU sheet 76. This collateral heat can be used to trigger hotmelt adhesives which can be placed in between the components 32 and the base layer 14 and/or between the TPU sheet 76 and the base layer 14 to further enhance the bonds between these parts of the shoe. The heat also makes the various components pliable and molds them to the last just as the TPU sheet 76 sets up and takes the shape of the last as it is forced into position by vacuum and/or the pressurized air.

After a designated period of time, the upper frame member 78 is moved away from the clamping member 70 to expose the thermoformed upper and sole structure, which are now encapsulated and bonded by the TPU sheet 76. The length of time that the heater is over the TPU sheet depends the melting temperature and thickness of the TPU sheet or other material, and the type of heater being used such as for example, if a single or double oven is being used. In the illustrated embodiment, the heater is positioned over and heats the TPU sheet 76 between 1-60 seconds.

It should be noted that the bonding characteristics of the TPU sheet 76 with the upper 12 and the sole structure 50 can be enhanced. For example, in an embodiment, hotmelts are applied directly to the TPU prior to forming, or a TPU powder is applied to a portion of the upper 12 and/or the sole structure 50 to enhance the bond between the TPU sheet 76, the upper 12 and/or the sole structure 50. Further, a mesh material or other suitable material may be placed over the seam between the upper 12 and the sole structure 50 to strengthen the connection between the upper and sole structure after the TPU sheet 76 has been thermoformed or overmolded onto the upper and sole structure. It should be appreciated that additional materials may be applied to the TPU sheet, fabric or components to enhance bonding. Additionally, fabrics forming the upper can be constructed with fibers having the same chemical makeup as the TPU sheet 76. These fibers are partially or completely coated with the overmolding material, namely the TPU forming the TPU sheet, to ensure enhanced bonding to the TPU sheet. Also by coating the fibers with the base material, i.e., the TPU, the fabric can be molded without the TPU sheet.

Also, as described above, during the thermoforming process, the TPU sheet 76 is conformed to the upper 12, the components 32 and the last 16 such that the material layer or layers of the upper are pressed into the circular recessed areas 22 and designs 24 in the outer surface of the last. This creates corresponding shapes in the upper 12 that also project at least partially into the interior of the upper. The inner projecting, shaped areas of the upper 12 help to maintain space between the inside surface of the upper 12 and a wearer's foot thereby creating spaces or pathways for air to travel about the foot and keep the wearer's foot drier and comfortable.

In the illustrated embodiment, a cutting tool is used to manual cut the foot opening 20 and around a bottom edge 108 (FIG. 12) of the sole structure 50 to separate the upper and the sole structure from the pedestal 66. The cutting tool is preferably a heated blade or knife but may be any suitable cutting tool. Alternatively, a trim plate or cover plate, or similar cutting device shield is attached to the mold member 88 to help cut away the excess portions of the TPU sheet 76 from the foot opening 20 and the bottom edge 108 of the sole structure as the upper frame member 78 and mold member 88 move downwardly onto the upper 12 and sole structure 50. In the latter embodiment, the thickness of the liner 94 can be increased or increased only in the cutting areas to help prevent damage to the liner during cutting of the excess TPU. A cover plate or shield may also be used to cover the tongue 46 and/or other parts of the upper 12 to protect these areas from being inadvertently cut or damaged during cutting. Alternatively, several cover plates are shaped to conform and cover one or more parts of the upper 12 to prevent inadvertent cutting of those parts during the trimming or cutting process. The cover plates are made of a durable material, such as a thermoplastic, that is strong enough to prevent penetration and/or cutting of the material by the cutting device. To further enhance the cutting of the excess TPU material from the shoe, a heat reflective material is attached to the cutting device adjacent to one or both sides of the cutting device to help prevent inadvertent contact between the knife and the upper, the midsole, the outsole or other portion of the shoe. In an embodiment, the heat reflective material is a syntactic foam that is heat resistant yet strong enough to withstand repeated cutting operations. In an example embodiment, the cutting tool is constructed similar to a pizza cutter with a round central blade attached to handle. Round washers made of the heat reflective material having a diameter that is smaller than the diameter of the blade are mounted on each side of blade to protect the portions of the shoe not being cut by the blade.

In another embodiment, the cover plate or trim plate is secured to the upper 12 prior to initiating the thermoforming process. The edge of the trim plate includes a groove in which a heated knife or laser is inserted for trimming the TPU from the thermoformed footwear. The trim plate can be machined with a high level of accuracy such that a laser or robotic trimming device can be used to automatically trim the TPU from the footwear. It should be appreciated that the trim plate is constructed so that at least a portion of the trim plate extends behind the cutting area so that there is a firm surface for the cutting tool to press against during the cutting process.

In an embodiment, the mold member 88 includes a die cutting surface or surfaces 130 (FIG. 17), such as a wall, ridge or blade, that extends from an inner surface of the mold member and is positioned on the inner surface to cut the TPU at a designated location or a plurality of locations on the base layer. The mold member 88 may include one or more die cutting surfaces 130. In operation, the die cutting surface or surfaces 130 of the mold member 88 cut the TPU on the base layer at the designated location or locations as it moves downwardly over the upper and/or sole structure. As stated above, the liner 94 could be thicker in the cutting areas to help prevent damage to the liner during the thermoforming process. Also, the material forming the mold member 88, preferably silicone, can be thicker or added to the areas of the mold member including the die cutting surfaces to apply uniform pressure to the die cutting surfaces during cutting and to help prevent the die cutting surfaces 130 from cutting or moving through the mold member 88 from the pressure on the die cutting surface(s) as the surfaces engage the platform supporting the upper 12 and/or sole structure 50.

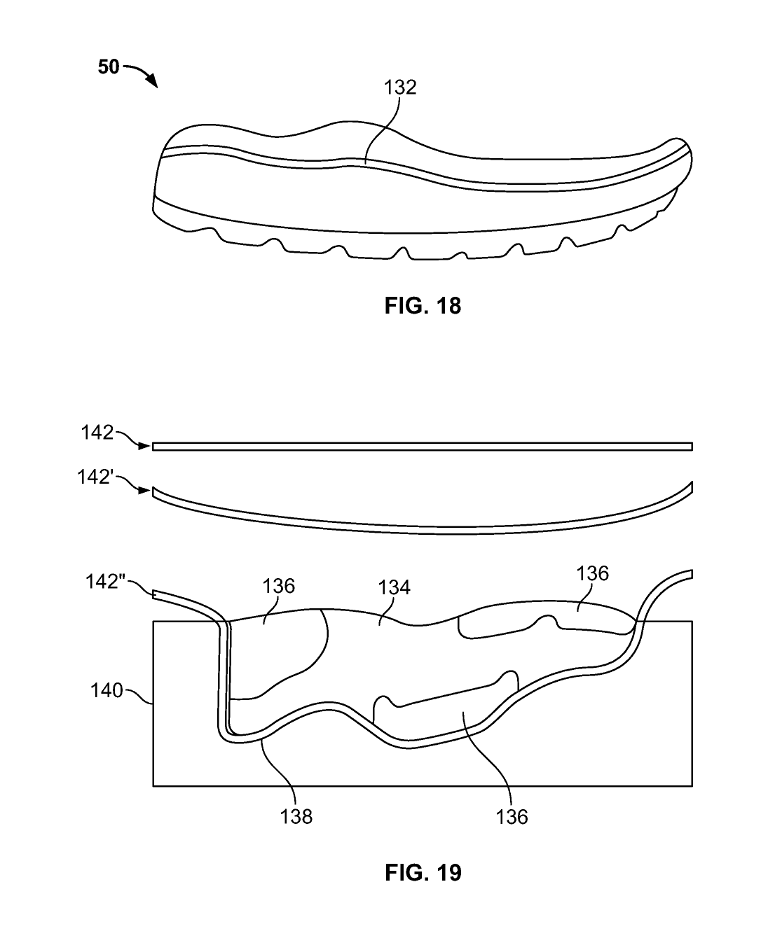

In another embodiment, one or more grooves are formed in the upper, in one or more of the components and/or in the sole structure to enable the excess TPU or other overmolded materials to be easily removed from the upper, the components and/or the sole structure. For example, FIG. 18 shows a groove 132 formed in the sole structure 50, and more specifically, in an outsole. The grooves act as a guide for a cutting tool so that a high level of cutting accuracy is not needed during the cutting or trimming process. Furthermore, the grooves help to hide the cut lines that would otherwise be visible on the outer surface of the upper, the components and/or the sole structure. Also, the width and/or depth of the grooves can be adjusted to simplify the cutting or trimming process. For example, a deep and narrow groove enables the excess TPU to be manually tom away from the upper, the components and/or the sole structure instead of cutting the excess TPU. A non-stick coating can also be applied to the cutting lines or areas to facilitate the removal of the excess TPU. It should be appreciated that any suitable cutting or trimming method may be used to remove the excess TPU from the upper, the components and/or the sole structure.

The outsole 54 is now attached to the thermoformed upper 12 and sole structure 50 using conventional attachment methods such as applying adhesive to and/or sewing the outsole to the bottom of the sole structure, namely the midsole. Prior to attaching the outsole 54, the edge of the TPU sheet 76 extending from the midsole 52 is cut and/or wrapped under the midsole so that the outsole secures the edge of the TPU between the midsole and the outsole when the outsole is attached to the midsole.

Alternatively, the thermoforming process may be used to attach the outsole 54 to the midsole 52 such that the upper 12, and the midsole 52 and the outsole 54 (collectively, the sole structure 50) are attached together by the TPU sheet 76. In an embodiment, an adhesive strip or adhesive tape is placed against the inner peripheral edge of the sole structure with the adhesive or sticky side facing outward and extends along a portion of the last. The bottom peripheral edge of the base material of the upper is then pressed against the adhesive strip to hold the base material, and thereby, the upper in place on the sole structure during the thermoforming process. In another embodiment, a slot or groove is formed along the peripheral edge of the sole structure so that the base material curves inwardly and at least partially under the upper to help hide the lower edge of the base material of the upper attached to the sole structure. Additionally, in another embodiment, a foxing material is attached over the seam between the upper and the sole structure and secured in place during the thermoforming process to further enhance the attachment of the upper to the sole structure.

In a further embodiment, the sole structure is made with a thermoplastic material, such as TPU, instead of rubber where the thermoplastic material has similar or better wet traction properties than rubber. Preferably, the sole structure is made with softer grades of the thermoplastic material having a hardness value of 50 to 60 Shore A. It should be appreciated that a thermoplastic material having any suitable hardness value may be used. During the thermoforming process, the TPU sheet is overmolded over the upper and the sole structure such that the TPU sheets covers the entire bottom surface of the sole structure to fixedly join the upper and sole structure together. The TPU sheet preferably has a thickness of one millimeter but may be any suitable thickness or combination of thicknesses. In use, the TPU material on the bottom of the sole structure wears away due to friction without any visible fraying along the periphery of the sole structure while a strong bond is maintained between the upper and the sole structure.

The thermoforming process described in the above embodiments bonds various footwear components and a sole structure to a base layer in a single step, which simplifies the footwear manufacturing process, reduces toxic adhesives and solvents typically used in the manufacturing process and significantly reduces labor costs. Also, since the thermoforming process perfectly shapes the upper to the last (shoe form) it requires little or no shaping inserts, reinforcements or post heating or setting tunnels.

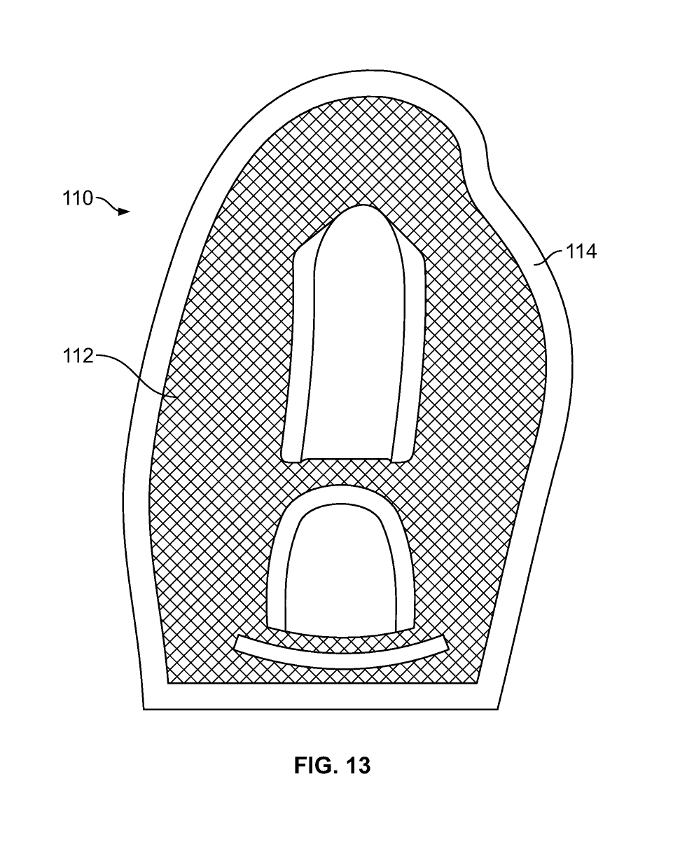

Referring to FIG. 13, in another embodiment, a base layer 110 including one or more materials 112 laminated with a TPU film 114 (the TPU is integrated in the base layer) is used to thermoform the upper. The laminated base layer 110 is strobel lasted and formed into a lasted upper 12, heated until the TPU film 114 in the base layer is formable (thermal-forming) and then vacuum-formed as described above. The laminated base layer 110 helps to eliminate thinning of thermoformed materials during the process and controls features of the TPU such as perforations, decorative features and textures. The laminated material also helps to hide the appearance of the TPU film/sheet (plastic appearance) on the outer surfaces of thermoformed footwear. It should be appreciated that upper materials, such as mesh and trim materials and/or the components, can be made of the same thermoplastic as the overmolded or integrated TPU, so that the materials all combine easily and form at the same temperatures and pressures. By having only one formable material layer for the base layer and the components, the process is simplified, streamlined and more cost effective than conventional footwear manufacturing processes.

In the above embodiment, the TPU laminated fabric may be made into one or more rolls that are used in the thermoforming process. Specifically, a part of a shoe, such as the upper, is cut out of the laminated fabric roll and then one or more components are attached to the shoe part and then thermoformed or overmolded with a moldable material such as the TPU described above. In the above embodiments, the laminated material may be attached to one material or positioned between or attached between two or more material layers where the heat formable material used to make the laminated base layer or laminated material may include a sheet of TPU, liquid TPU applied to a material or materials, TPU powder or any suitable heat formable material.

In another embodiment, the lasted upper 12 can be molded in an inverted or upside down position. During the thermoforming process, the TPU sheet has a tendency to decrease in thickness, i.e., thins, as it stretches over the upper and sole structure. Thus, inverting the upper 12 controls the thinning of the TPU sheet and thereby the thickness of the sheet and strengthens the bond between the upper and sole structure. In particular, this process is particularly effective for attaching an outsole to the midsole. This process can also be used to secure sole components such as rubber wear pads or logos to the sole structure via the overmolded TPU. It also drives heat into these components to help adhere the components to the sole structure. Any rubber components intended to add traction or durability to the sole structure can be exposed using a device similar to the “cover plate” or shield described above or the TPU can simply be die cut to expose the rubber.

In an embodiment, the TPU sheet is texturized to add perceived physical features and qualities to the upper and make the TPU on the upper virtually invisible after the thermoforming process is complete. In conventional methods, texture must be embossed into the TPU sheet. During thermoforming, the texture tends to melt out especially in deep draw thermoforming. By attaching various stretch fabrics, particularly nylon based fabrics, to the silicone liner in the mold member, an array, including very fine textures, can be transferred to the TPU sheet during the molding process. Preferably, a nylon-based material is used to add texture to the TPU sheet as nylons do not adhere to TPU. As such, the texturizing material should stretch as least 400% in each direction, and preferably, 600% or more in each direction. It should be appreciated that other suitable materials may be used in place of fabric. Texturizing can also be accomplished by pre-formed or shaped bladders that mimic the shape of an article of footwear such as a shoe. These bladders have very defined textures and geometries imprinted on them, including decorative and functional geometries which are then transferred to the overmolded thermoplastic on the shoe.

In another embodiment, to improve the breathability of the base material and the circulation of air within the shoe, the TPU sheet is pre-perforated with a plurality of holes prior to being overmolded onto the upper and sole structure. The pre-perforated TPU sheet is then accurately positioned between the upper and/or sole structure and the mold member prior to heating and forming. These holes will distort during thermoforming which can be controlled via pre-distortion software design. The distortion of the holes can also be controlled by attaching pre-perforated materials to the upper.

Referring to FIG. 19, an inverted or a negative molding process IS illustrated where a base layer 134 and/or the components 136 are placed in a cavity 138 of a negative mold 140 such that the inner surfaces of the base layer and/or the components are inverted exposed inside of the upper. A heat formable material or other formable material, such as a TPU sheet 142, is heated to be a moldable TPU sheet 142′ and then sheet 142″ is vacuum-formed to the inner surfaces of the base layer 134 and the components 136 to secure the base layer and the components together to form the upper.

The negative molding process enables the components to be counter-sinked with the base layer and enables very fine textures to be imprinted on the formable material.

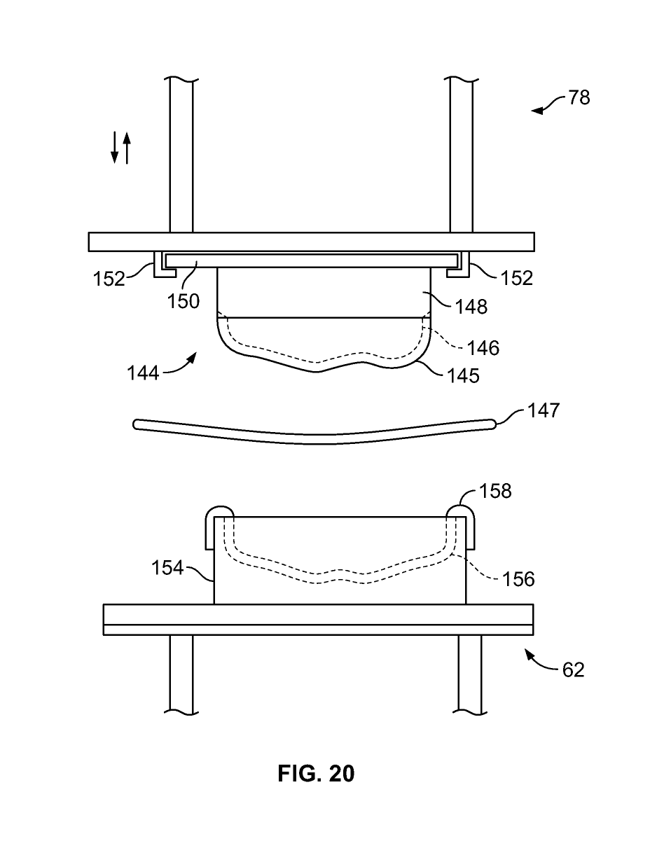

Referring to FIG. 20, another embodiment of the inverted or negative molding process is shown where a footwear upper 144, and more specifically, a base material 145 of the upper is secured to a last 146. The upper 144 is secured to a sole structure 145 that is in turn, secured to a shoe retainer or shoe cassette 148 having a shape that corresponds to the shape of the sole structure 145. To secure the sole structure 145 to the shoe retainer 148, an inwardly projecting edge is formed on the shoe retainer 148 such that the sole structure 145 is pushed into an opening in the shoe retainer until at least a portion of the sole structure 145 fits into or snaps into the edge of the shoe retainer 148 to form a tongue-in-groove type connection between the sole structure 145 and the shoe retainer 148.

In the illustrated embodiment, the shoe retainer 148 is attached to or integrally formed with a plate 150 that slides within spaced mounting brackets 152 on the upper frame member 78 of the thermoforming machine. The plate 150 may also be attached to the upper frame member 78 by screws or other suitable connectors. By having the shoe retainer 148 attached to the plate 150, the shoe cassette or shoe retainer assembly is easily transferred to other manufacturing machines and indexed to significantly enhance the accuracy of the manufacturing process.

In this embodiment, the upper frame member 78 moves the upper 144 downward into a heated TPU sheet 147 and then into a corresponding bottom mold member 154 attached to the lower frame member 62. The bottom mold member 154 includes a recessed area 156 with an inner surface having a shape that corresponds to the shape of the upper 144 so that the upper moves into the bottom mold member 154 during the thermoforming process. A non-stick liner 158 made of a silicone material or other suitable material is placed in and secured to the bottom mold member 154. The liner 158 helps to prevent the thermoformed upper from sticking to the bottom mold member. Also as described above, in an embodiment, the liner 158 includes a textured surface for forming a corresponding texture in the TPU on the upper.

In another embodiment, an upper is positioned on a sole structure and a tape made of a thermoplastic material is heated and placed over the seam between the upper and the sole structure such that at least a portion of the tape extends onto the upper and the sole structure. It should be appreciated that the tape may be made out of any suitable material or combination of materials. After being heated, the tape is then pressed onto the seam, similar to the thermoforming process described above, to fixedly join the upper to the sole structure. Alternatively, the tape is applied without pre-heating it. It should be appreciated that the tape may have a uniform width and thickness or may have different widths and/or thicknesses depending on the location and positioning of the tape. In embodiment, the thickness of the tape is one millimeter but may any suitable thickness.

The thermoforming process described above, shapes and combines various components to a base layer in one step, significantly reducing the required labor, the amount of toxic or hazardous adhesives and solvents and much of the traditional equipment. Further, labor costs have skyrocketed, quality production is very difficult and expensive to control and shipping costs and import duties are also very expensive and energy consuming. As a result, it has become very desirable to produce footwear as close as possible to the point of consumer sale. For example in an embodiment, the present thermoforming process is employed in a retail machine, such as a footwear vending machine, and thermoforms footwear based on predetermined styles that are selected by a consumer or based on footwear components, styles and colors selected by a consumer. In this way, such retail machines can be placed at retail stores, malls, nightclubs, or any suitable location. It should be appreciated that the retail machine may manufacture shoes as described above based on any suitable manufacturing process other than the thermoforming process. The present footwear thermoforming process addresses these issues in a positive way for footwear brands as well as the environment.

Moreover, footwear soles are generally attached to uppers by adhesives. This process involves cleaning the surfaces of both the sole and upper, buffing, priming and cementing the uppers and soles together. After the adhesive dries, it is activated usually by heat and then the upper and sole are carefully pressed together. This process is fraught with problems and prone to operator mistakes and is toxic or hazardous to workers and even to consumers. Further, a significant percentage of the pollution associated with manufacturing footwear is generated during this process. There are other methods of attaching uppers to soles, however, the methods are very limited with regard to materials, design and function. Direct injection for instance, requires that the materials be denser, and therefore heavy, and the associated equipment is prohibitively expensive and does not fit into the rapid fashion changes of modern retail. Sole stitching is also very restrictive and not applicable to most types of shoes The above footwear thermoforming process of the entire shoe (including the sole structure) with a thin layer of thermoplastic completely eliminates the above chemical bonding and labor intensive processes.

Additionally, because thermoforming is a very low pressure molding process, metal tooling and equipment typical in footwear manufacturing are not necessary and usually not desirable. This greatly reduces the tooling costs, new product lead times, equipment changeover time and difficulty. Smaller lighter tools do not require equipment to change and can easily be replaced at a low cost if damaged. This is also an advantage since hotmelts and thermoplastics are designed to adhere to anything these substances contact.

In the above embodiments, the upper and/or sole structure are thermoformed using a particular thermoforming process. It should be appreciated that any suitable thermoforming process may be used to form the upper and/or sole structure, including but not limited to, drape molding and matched mold forming.

While particular embodiments of a thermoformed article of footwear and method for thermoforming footwear have been described herein, it will be appreciated by those skilled in the art that changes and modifications may be made thereto without departing from the invention in its broader aspects and as set forth in the following claims.

We claim:

1. A method for assembling a footwear, comprising:
providing an inverted negative mold of the footwear;
placing a perforated TPU sheet inside the mold;
heating the TPU sheet;
placing an upper and a base component in the mold against the TPU sheet;
applying a vacuum to apply the TPU sheet against the upper and base component to bond the base component to the upper; and
controlling a distortion of holes in the perforated TPU sheet using a pre-distortion software.

2. The method for assembling a footwear of claim 1, wherein the controlling the distortion of holes includes attaching pre-perforated material to the upper.

3. The method for assembling a footwear of claim 1, wherein the heating the TPU is conducted prior to being placed in the mold.

4. The method for assembling a footwear of claim 1, wherein the base component is secured to a last.

5. The method for assembling a footwear of claim 1, wherein the mold is connected to a shoe cassette.

6. The method for assembling a footwear of claim 1, wherein a connection of the mold to the shoe cassette uses a tongue-in-groove coupling.
